(19) United States
(12) Patent Application Publication
(10) Pub. No.: US 2005/0038927 A1
(43) Pub. Date: Feb. 17, 2005

(54) Method and apparatus for automatically installing driver and computer-readable recording medium for storing computer program

(76) Inventors: Jun-young Choi, Suwon-si (KR); Young-dal Oh, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/895,930

(22) Filed: Jul. 22, 2004

(30) Foreign Application Priority Data
Aug. 16, 2003 (KR) 2003-56720

(51) Int. Cl. G06F 3/00

(52) U.S. Cl. 710/8

(57) ABSTRACT

There are provided an automatic driver installation method and apparatus and a computer readable recording medium for storing a computer program. The automatic driver installation method includes: (a) determining whether the device is connected to the host; (b) fetching device identification information specifically representing the connected device from the device if it is determined that the device is connected to the host; (c) extracting location information comprised of at least one location in which the driver exists, from the device identification information if no driver adapted to drive the connected device has been installed in the host; and (d) fetching the driver from a corresponding location among at least one location indicated by the extracted location information, and installing the driver in the host.

### PRIORITY

This application claims the benefit under 35 U.S.C. §119(a) of Korean Patent Application No. 2003-56720, filed on Aug. 16, 2003, in the Korean Intellectual Property Office, the entire disclosure of which is hereby incorporated by reference.

### BACKGROUND OF THE INVENTION

1. Field of the Invention

The present invention relates to a driver for driving a device such as a printer, a scanner, or a sound card, which is installed in a host or provided as an external source to the host. More particularly, the present invention relates to a method and apparatus for automatically installing a driver and a computer-readable recording medium for storing a computer program for automatic installation of a driver.

2. Description of the Related Art

Unlike other home appliances, to connect a device to a host to a personal computer, for example, and then to allow communications between the device and the host and between the device and a user, a device control program called a ‘driver’ must be installed in the host.

A conventional driver installation method will now be described. First, an operating system (OS) of a host recognizes a device connected to the host. At this time, a user locates a driver in media capable of being recognized by the operating system. The media can be a hard disk drive (HDD), a floppy disc drive (FDD), a movable disk such as a memory stick or a memory card, or a CDROM, for example. Then, the host requests the user to designate a location of a driver to drive the device. The user designates a location of a driver to drive the device, and then the host fetches and installs a driver located in the location designated by the user.

Another conventional driver installation method will be now be described. An operating system (OS) of a host recognizes a device connected to the host. At this time, a user locates a driver in media capable of being recognized by the operating system. Then, the host requests the user to designate a location of a driver to drive the device and the user searches for the location of the driver instead of designating the location of the driver. At this time, when the location of the driver is found, the user executes an installation program located at the location of the driver and installs the driver.

In a case of using the above-described conventional driver installation methods, since most users little understand the concept of a driver, they may experience difficulties in installing a driver for driving a device on a host. That is, many users have difficulties in locating a driver in media capable of being recognized by the operating system and correctly designating the location of the driver. For this reason, it would be preferably for manufacturers of devices to support the devices so that users can easily install a driver without errors. In addition, due to changes in the environment in which a host is used, the probability that a driver for driving a device will need to be updated is increased and accordingly service requests are increased, thereby causing an increase in service cost. Also, since the manufactures of devices should manufacture media capable of storing drivers for driving the devices separately and distribute them to users, the manufacturing cost of devices is increased. Also, in a case where a user loses or misplaces the media which store the drivers, the user may experience difficulties in downloading and correctly installing a driver corresponding to his/her own device model through an Internet home page managed by the manufacturing company of the device.

Recently, in the case of the Windows XP operating system, it is possible to automatically install certain drives that are included in the operating system of the host. However, this does not account for newly developed drivers. Thus, it is impossible to automatically install a driver newly developed by a manufacturing company of a device.

To solve such a problem, a conventional driver installation method is disclosed in Korean Patent No. 2001-22457 entitled “Method for installing device driver”. According to the conventional driver installation method, an operating system of a host downloads a driver over the Internet and installs a driver using a URL (Uniform Resource Locator) address read from a device. Such a conventional driver installation method should include an automatic driver installation function in which an operating system reads a URL address, downloads a driver according to the read URL address, and automatically installs the downloaded driver. If the conventional driver installation method does not include such an automatic driver installation function, it cannot automatically install a driver, and the sources that provide drivers are limited to only the Internet. That is, the conventional driver installation method cannot download and automatically install a driver from different sources other than the Internet.

### SUMMARY OF THE INVENTION

A first object of the present invention is to provide an automatic driver installation method which automatically installs a driver for driving a device when the device is connected to a host.

A second object of the present invention is to provide an automatic driver installation apparatus which automatically installs a driver for driving a device when the device is connected to a host.

A third object of the present invention is to provide a computer-readable medium for storing a computer program that automatically installs a driver for driving a device when the device is connected to a host

To achieve the first object, there is provided a method for automatically installing a driver which drives a device in a host, the method comprising: (a) determining whether the device is connected to the host; (b) if it is determined that the device is connected to the host, fetching device identification information from the device that specifically represents the connected device; (c) if no driver adapted to drive the connected device has been installed in the host, extracting location information comprised of at least one location in which the driver exists, from the device identification information; and (d) fetching the driver from a corresponding location among at least one location indicated by the extracted location information, and installing the driver in the host.

Also, to achieve the first object, there is provided a method for automatically installing a driver that drives a device on a host, the method comprising: determining whether the device is connected to the host; if it is determined that the device is connected to the host, fetching device identification information from the device that specifically represents the connected device; if no driver adapted to drive the connected device has been installed in the host, extracting a query string from the fetched device identification information; transmitting the device identification information with the query string to a server that provides the driver; and receiving the driver from a server that found the driver adapted to drive the device using the query string and the device identification information, and installing the driver in the host.

To achieve the second object, there is provided an automatic driver installation apparatus for installing a driver that drives a device in a host, the automatic driver installation apparatus comprising a first connection checker, which checks whether the device is connected to the host and outputs the checked result as a first control signal; a first information input part, which fetches device identification information from the device that specifically represents the connected device, in response to the first control signal; a first driver checker, which checks whether a driver adapted to drive the connected device has been installed in the host and outputs the checked result as a second control signal; an information extractor, which extracts location information comprised of at least one location in which the driver exists from the device identification information received from the first information input part, in response to the second control signal; and a first driver installation unit, which fetches the driver from a corresponding location among the at least one location indicated by the extracted location information received from the information extractor, and installs the driver in the host.

To achieve the second object, there is provided an automatic driver installation apparatus for installing a driver that drives a device on a host, the automatic driver installation apparatus comprising a second connection checker, which checks whether the device is connected to the host and outputs the checked result as a first control signal; a second information input part, which fetches device identification information from the device that specifically represents the connected device in response to the first control signal; a second driver checker, which checks whether a driver adapted to drive the connected device has been installed in the host and outputs the checked result as a second control signal; a query string extractor, which extracts a query string from the device identification information received from the second information input part, in response to the second control signal; an information transmitter, which transmits the device identification information with the query string to the server that provides the driver; and a second driver installation unit, which receives the driver from a sever that finds the driver adapted to drive the device, using the query string and the device identification information, and installs the driver in the host.

To achieve the third object, there is provided a computer readable recording medium for storing at least one computer program which installs a driver to drive a device in a host, the computer program determining whether the device is connected to the host; if it is determined that the device is connected to the host, fetching device identification information from the device that specifically represents the connected device; if no driver adapted to drive the connected device has been installed in the host, extracting location information comprised of a location in which the device exists, from the device identification information; and fetching the driver from the location indicated by the extracted location information and installing the driver in the host.

To achieve the third object, there is provided a computer readable recording medium for storing at least one computer program which installs a driver to drive a device on a host, the computer program determining whether the device is connected to the host; if it is determined that the device is connected to the host, fetching device identification information from the device that specifically represents the connected device from the device; if no driver adapted to drive the connected device has been installed in the host, extracting a query string from the device identification information; transmitting the device identification information with the query string to a server which provides the driver; and receiving the driver from a sever that find the driver adapted to drive the device using the query string and the device identification information, and installing the driver in the host.

### BRIEF DESCRIPTION OF THE DRAWINGS

The above and other features and advantages of the present invention will become more apparent by describing in detail exemplary embodiments thereof with reference to the attached drawings in which:

FIG. 1 is a flowchart illustrating an automatic driver installation method according to an embodiment of the present invention;

FIG. 2 is a flowchart illustrating step 18 of FIG. 1, according to an embodiment of the present invention;

FIG. 3 is a flowchart illustrating an automatic driver installation method according to another embodiment of the present invention;

FIG. 4 is a block diagram of an automatic driver installation apparatus according to an embodiment of the present invention;

FIG. 5 is a block diagram of an automatic driver installation apparatus according to another embodiment of the present invention; and

FIGS. 6a through 6h are views for describing the automatic driver installation method and apparatus according to an embodiment of the present invention.

Throughout the drawings, it should be understood that like reference numbers are used to represent like features and structures.

### DETAILED DESCRIPTION OF THE INVENTION

Hereinafter, an automatic driver installation method according to an embodiment of the present invention will be described in detail with reference to the appended drawings.

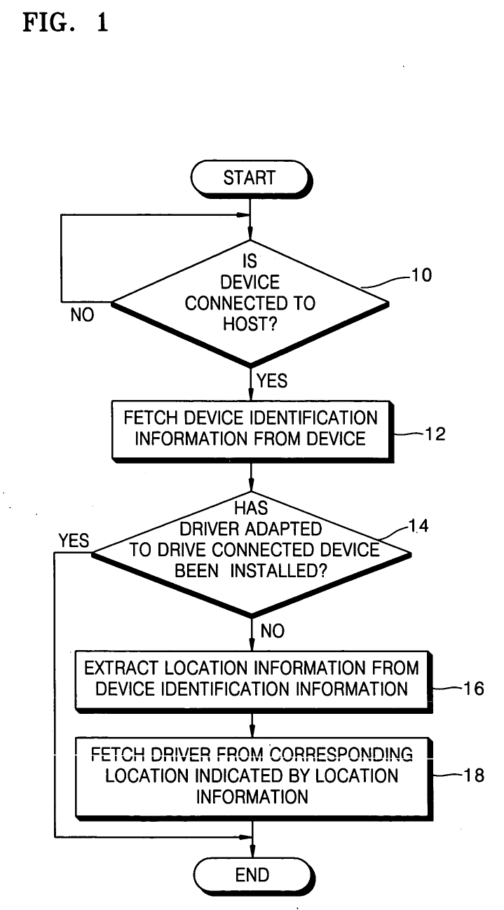

FIG. 1 is a flowchart illustrating an automatic driver installation method according to an embodiment of the present invention, which comprises steps 10 through 18 of automatically installing a driver (not shown) on a host (not shown) using location information extracted from driver identification information when a device (not shown) is connected to the host.

The automatic driver installation method according to an embodiment of the present invention automatically installs a driver for driving a device on a host such as a personal computer as follows.

The automatic driver installation method of FIG. 1 according to an embodiment of the present invention determines whether a device is connected to a host (step 10). Here, the device may be a peripheral device such as a printer or a scanner attached to the outside of the host, or an internal device such as a sound card installed inside the host.

If it is determined that no device is connected to the host, step 10 is performed again.

On the contrary, if it is determined that a device is connected to the host, device identification information representing the connected device is fetched from the device (step 12). That is, after a device is connected to a host through a cable connected to a parallel port of the host or local part for a universal serial port and power is supplied to the host and the device, the host fetches identification information from the device connected to it.

After step 12, it is determined whether a driver adapted to drive the connected device has been installed in the host (step 14). If it is determined that a driver adapted to drive the device connected to the host has been installed in the host, the automatic driver installation method shown in FIG. 1 is terminated. However, if no driver adapted to drive the device connected to the host has been installed in the host, the host extracts location information, such as information related to at least one location in which a driver exists, from the device identification information (step 16). Here, according to an embodiment of the present invention, the extracted location information and the device identification information may have the same data format, that is, a key data format. Also, the extracted location information can include a location on a network in which a driver exists, that is, at least one among a universal resource locator (URL), an external location outside the host, or an internal location inside the host. In addition, the extracted location information can include identifiers URL, EM, and IM according to locations and the number n of locations. Here, URL indicates that a driver is located on the Internet, EM indicates that a driver is located in an external storage unit, such as a source external to the host, such as a hard disc of the device or universal serial bus (USB) memory device, and IM indicates that the driver is located in an internal storage unit installed in the host, such as a CD-ROM.

For example, the format of device identification information defined in an IEEE1284 standard is described as follows. First, first and second bytes of device identification information represent the length of a character string of the device identification information. Keys and values follow the second byte. Here, each of the keys are separated by semicolons (;) and each of the keys and values are separated by colons (:). Each of the values are separated by a comma (,). Currently used keys for device identification information include MFG (or, Manufacturer) indicating the name of the manufacturer of the device, CMD indicating a command name used in the device, MODEL (or, MDL) indicating a model name of the device, a CLASS indicating a product group of the device (printer or monitor, etc.), and DES indicating a description of the device. The device identification information is listed in table 1 below.

TABLE 1

| Byte of device | | | | |
|---|---|---|---|---|
| identification | | | | |
| information | Bit number | Key name | Description | Remarks |
| 0 | 0-7 | — | Entire length of device | |
| | | | identification information | |
| | | | (LOWER) | |
| 1 | 8-15 | — | Entire length of device | |
| | | | identification information | |
| | | | (UPPER) | |
| 2-N | 16-n1 | MFG | Device manufacturer's | n1-(16-1): length of |
| | | | name | entire character string |
| | | | | of MPG |
| | n1+ 1− n2 | CMD | Command name | n2-n1: length of entire |
| | | | | character string of |
| | | | | CMD |
| | n2 + 1 − n3 | MDL | Model name | n3-n2: length of entire |
| | | | | characater string of |
| | | | | MDL |
| | n3 + 1 − n4 | CLASS | Class name | n4-n3: length of entire |
| | | | | character string of |
| | | | | CLASS |
| | n4 + 1 − n5 | DES | Model description | n5-nm4: length of entire |
| | | | | character string of DES |
| | n5 + 1 − n6 | DRVSRC | n: number of locations | n6-n5: length of entire |
| | | | | character string of n |
| | n6 + 1 − n7 | | URL: URL address | n7-n6: length of entire |
| | | | information | character string of URL |
| | | | | information |
| | n7 + 1 − n8 | | EM: location information | n8-n7: length of entire |
| | | | of external stroage unit | character string of EM |
| | | | | information |
| | n8 + 1 − n9 | | IM: location information | n9-n8: length of entire |
| | | | of internal storage unit | character string of IM |
| | | | | information |
| | n9 + 1 − n10 | | . . .: other media location | n10-n9: length of other |
| | | | information | media information |

Location information DRVSRC which is extracted from such device identification information and has a key data format can be for example as follows: DRVSRC: 3, URL=http://www.sec.co.kr/product/printer/download/mjc2700. exe, EM=“EXTMEDIA_LABEL” \SETUP.EXE, IM=“INTMEDIA_LABEL” \SETUP.EXE. Here, the numeral ‘3’ represents the number n of locations in which a driver exists. That is, n=3 represents that the driver is provided in three locations. In the location information, http://www.sec.co.kr/product/printer/download/mjc2700. exe represents a correct address of an Internet website that provides the driver. The correct address of the Internet home page can be substituted with a query string. Also, EXTMEDIA_LABEL represents a label of an external storage unit and SETUP.EXE represents the name of a file to be executed after the external storage unit finds the driver. Also, INTMEDIA_LABEL represents a label of the internal storage unit and SETUP.EXE represents the name of a file to be executed after the internal storage unit finds the driver.

Meanwhile, after step 16 in step 18, the host fetches and installs a driver from a corresponding location among at least one location indicated by the extracted location information. In other words, the host fetches and installs a driver from a corresponding location indicated by the extracted location information, that is, from a location on a network in which a driver exists, an internal location inside the host, or an external location outside the host.

Hereinafter, step 18 shown in FIG. 1 will be described.

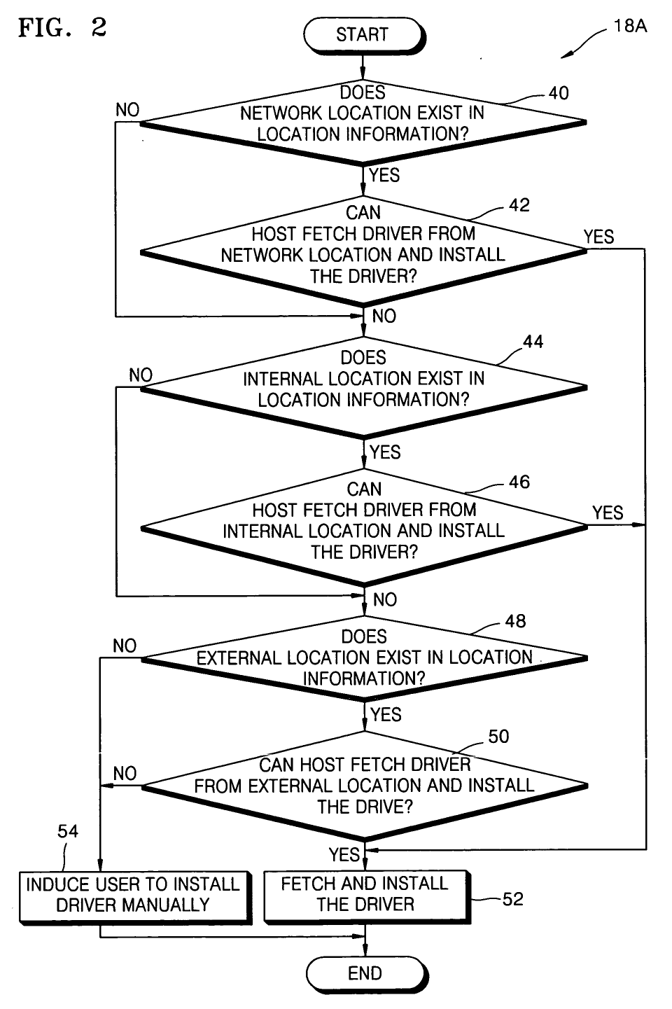

FIG. 2 is a flowchart illustrating step 18 of FIG. 1, according to a preferred embodiment 1 8 A of the present invention, wherein step 18 comprises steps 40 through 54 of checking locations included in the location information one by one, fetching a driver from a corresponding location capable of providing a driver, and installing the driver.

In step 40, it is determined whether a location on the network exists in the location information extracted in step 16. Here, the address on the network can represent a correct address of a home page that provides a driver over the Internet.

If it is determined that the network location exists in the extracted location information, in sep 42, it is determined whether a host can access the network location recorded on the extracted location information, fetch a driver from the location, and install the driver. If it is determined in step 40 that a network location does not exist in the location information, or in step 42 that the host cannot access the location on the network, or that the host can access the location on the network but cannot fetch a driver from the location and install the driver, it is determined in step 44 whether an internal location exists in the extracted location information.

If it is determined that an internal location exists in the extracted location information, it is determined in step 46 whether the host can fetch a driver from the internal location and install the driver. If it is determined in step 44 that an internal location does not exist in the location information, or in step 46 that the host cannot fetch and install a driver from the internal location, it is determined in step 48 whether an external location exists in the extracted location information.

If it is determined in step 48 that an external location exists in the extracted location information, it is determined in step 50 whether the host can fetch and install a driver from the external location.

If it is determined in step 42, 46, or 50 that the host can access the location on the network, the internal location, or the external location and fetch and install a driver from the location, in step 52, the host accesses the location on the network, the internal location, or the external location and fetches and installs a driver from one of the locations.

If it is determined in step 48 that an external location does not exist in the extracted location information, or in step 50 that the host cannot access the external location and fetch and install a driver from the external location, in step 54, the host induces a user to do a manual installation of the driver. That is, the host requires a user to manually install the driver.

In the above-described step 18A shown in FIG. 2, the network location among the three locations from which the driver is fetched is checked first, the internal location is checked second, and the external location is checked last. However, according to another embodiment of the present invention, the three locations can be checked in any order. For example, the internal location may be checked first, the external location may be checked second, and the location on the network may be checked last. Alternatively, it is possible that the external location is checked first, the location on the network is checked second, and the internal location is checked last.

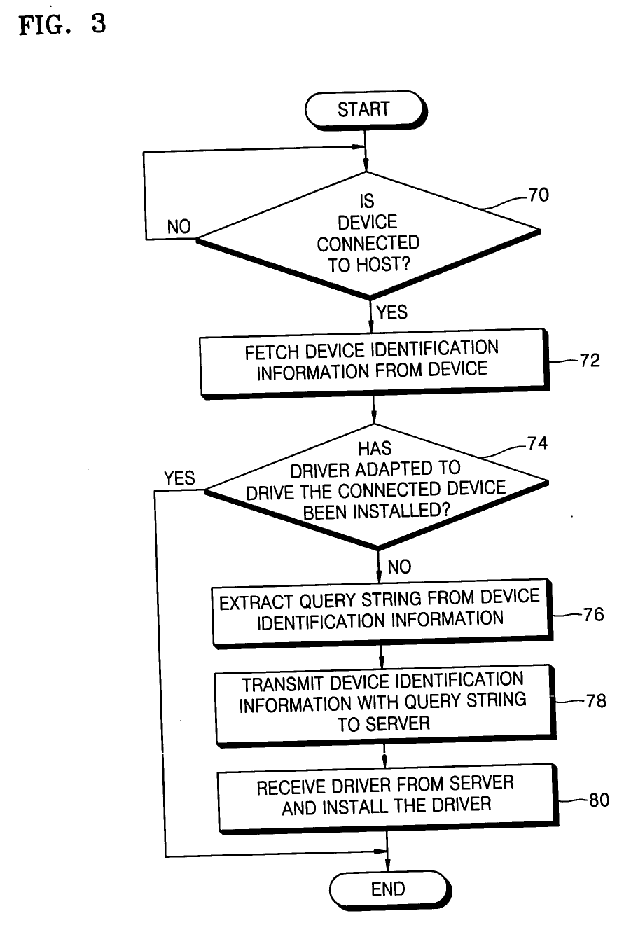

FIG. 3 is a flowchart illustrating an automatic driver installation method according to another embodiment of the present invention, wherein the automatic driver installation method comprises steps 70 through 80 of automatically installing a driver using a query string extracted from device identification information when a device is connected to the host.

In step 70 of this embodiment of the automatic driver installation method, it is determined whether a device is connected to a host. If it is determined that no device is connected to the host, step 70 is performed again.

On the contrary, if it is determined that a device is connected to the host, in step 72, the host fetches device identification information specifically representing the device connected to the host, from the device. After step 72, it is determined in step 74 whether a driver adapted to drive the device connected to the host has been installed in the host. If it is determined that a driver adapted to drive the device connected to the host has been installed in the host, the automatic driver installation method shown in FIG. 3 is terminated. However, if it is determined that no driver adapted to drive the device connected to the host has been installed in the host, in step 76, a query string is extracted from the device identification information obtained from the device. Here, the query string contains contents requesting a server that provides a driver through a network to find and provide a driver.

After step 76, in step 78, the host transmits the device identification information with the extracted query string to the server that provides the driver. The device identification information transmitted to the server can be limited to a model name, or related identification information, of the device.

After step 78, the server which received the query string and the device identification information finds a driver adapted to drive the device presently connected to the host using the query string and the device identification information. The server sends the driver to the host, and the host receives the driver and installs the driver thereon at step 80.

The above-described automatic driver installation method shown in FIG. 1 or 3 can be performed by an operating system (OS) of the host.

Hereinafter, the configuration and operation of an automatic driver installation apparatus according to an embodiment of the present invention will be described with reference to the appended drawings as follows.

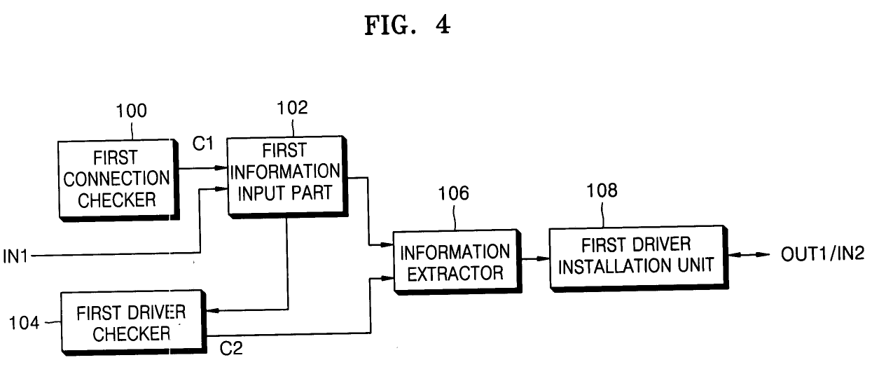

FIG. 4 is a block diagram of an automatic driver installation apparatus according to an embodiment of the present invention, wherein the automatic driver installation apparatus comprises a first connection checker 100, a first information input part 102, a first driver checker 104, an information extractor 106, and a first driver installation unit 108.

The automatic driver installation apparatus shown in FIG. 4 performs the automatic driver installation method shown in FIG. 1.

To perform step 10 shown in FIG. 1, the first connection checker 100 checks whether a device is connected to a host, and outputs the checked result as a first control signal C1 to the first information input part 102.

To perform step 12, the first information input part 102 receives device identification information specifically representing the connected device from the device through an input terminal IN1, in response to the first control signal C1. For example, if it is recognized through the first control signal C1 that a device is connected to the host, the first information input part 102 receives device identification information from the connected device through an input terminal IN1.

To perform step 14, after the first information input part 102 receives the device identification information completely, the first driver checker 104 checks whether a driver adapted to drive the device connected to the host has been installed in the host and outputs the checked result as a second control signal C2 to the information extractor 106.

To perform step 16, if it is recognized through the second control signal C2 received from the first driver checker 104 that no driver adapted to drive the device connected to the host has been installed in the host, the information extractor 106 extracts location information for at least one location in which a driver exists, from the device identification information received from the first information input part 102, and outputs the extracted location information to the first driver installation unit 108.

To perform step 18, the first driver installation unit 108 fetches a driver from a corresponding location among at least one location indicated by the extracted location information received from the information extractor 106, and installs the driver in the host. To achieve this, the first driver installation unit 108 requires a driver existing at a network location, an internal location inside the host, or an external location outside the host through an output terminal OUT1, and receives a driver existing at a network location, an internal location inside the host, or an external location outside the host through an input terminal IN2. That is, the first driver installation unit 108 shown in FIG. 4 performs step 18 A shown in FIG. 2.

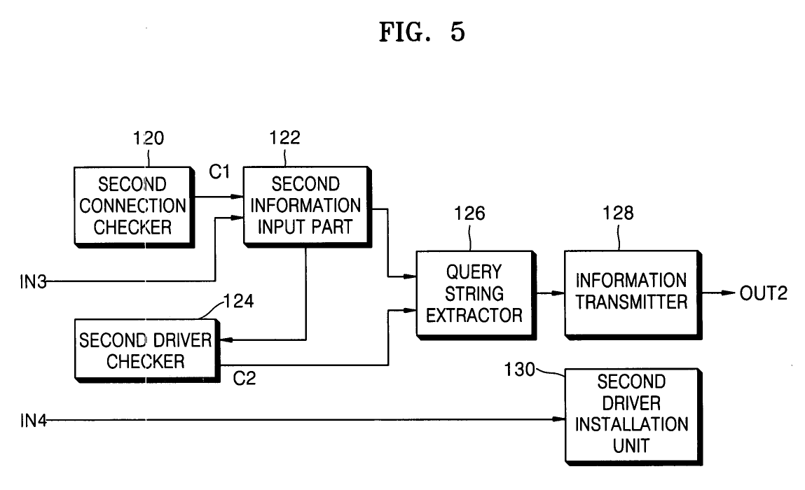

FIG. 5 is a block diagram of an automatic driver installation apparatus according to another embodiment of the present invention, wherein the automatic driver installation unit comprises a second connection checker 120, a second information input part 122, a second driver checker 124, a query string extractor 126, an information transmitter 128, and a second driver installation unit 130.

The automatic driver installation apparatus shown in FIG. 5 performs the automatic driver installation method shown in FIG. 3.

To perform step 70 shown in FIG. 3, the second connection checker 120 checks whether a device is connected to the host, and outputs the checked result as a first control signal C1 to the second information input part 122.

To perform step 72, the second information input part 122 receives device identification information specifically representing the connected device from the device through an input terminal IN3, in response to the first control signal C1 received from the second checker 120. For example, if it is recognized through the first control signal C1 that a device is connected, to the host, the second information input part 122 receives device identification information from the device through the input terminal IN3.

To perform step 74, after the second information input part 122 receives the device identification information completely, the second driver checker 124 checks whether a driver adapted to drive the device connected to the host has been installed in the host, and outputs the checked result as a second control signal C2 to the query string extractor 126.

To perform step 76, if it is recognized through the second control signal C2 received from the second driver checker 124 that no driver adapted to drive the device connected to the host has been installed in the host, the query string extractor 126 extracts a query string from the device identification information received from the second information input part 122 and outputs the extracted query string to the information transmitter 128.

To perform step 78, the information transmitter 128 transmits the device identification information with the query string to a server (not shown) that provides a driver through an output terminal OUT2.

To perform step 80, the second driver installation unit 130 receives a driver from the server through an input terminal IN4 and installs the driver in the host. To achieve this, the server finds a driver adapted to drive the device using the device identification information and the query string transmitted from the information transmitter 128 and outputs the found driver to the second driver installation unit 130.

The automatic driver installation apparatus shown in FIG. 4 or 5 can be installed in the host to which a device is connected.

Hereinafter, a computer readable recording medium for storing a computer program for automatic driver installation, according to an embodiment of the present invention, is described as follows.

According to an embodiment of the present invention, a computer readable recording medium for storing at least one computer program which automatically installs a driver adapted to drive a device in a host, comprises a first set of instructions adapted to determine whether a device is connected to the host; a second set of instructions adapted to fetch device identification information from the device that specifically represents the connected device if the device is connected to the host; a third set of instructions adapted to extract location information being information for a location in which a driver exists from the device identification information if no driver adapted to drive the connected device has been installed in the host; and a fourth set of instructions adapted to fetch a driver from a location indicated by the extracted location information and install the driver in the host.

According to another embodiment of the present invention, a computer readable recording medium for storing at least one computer program which automatically installs a driver adapted to drive a device in a host, comprises a first set of instructions adapted to determine whether a device is connected to the host; a second set of instructions adapted to fetch device identification information from the device that specifically represents the connected device if the device is connected to the host; a third set of instructions adapted to extract a query string from the device identification information if no driver adapted to drive the connected device has been installed in the host; a fourth set of instructions adapted to transmit the device identification information with the query string to a server that provides a driver; and a fifth set of instructions adapted to receive a driver adapted to drive the device from a server that finds the driver using the query string and the device identification information, and install the driver in the host.

As described above, in a case where automatic driver installation according to an embodiment of the present invention is performed by a program, it is possible to automatically install a driver even though an operating system of a host cannot perform the automatic driver installation method shown in FIG. 1 or 3, since a program for automatic driver installation is provided to a user over the Internet or through an external memory, or through any other suitable method.

Hereinafter, the automatic driver installation method shown in FIG. 1 and the automatic driver installation apparatus shown in FIG. 4, according to an embodiment of the present invention, are described with reference to user interface screens as follows.

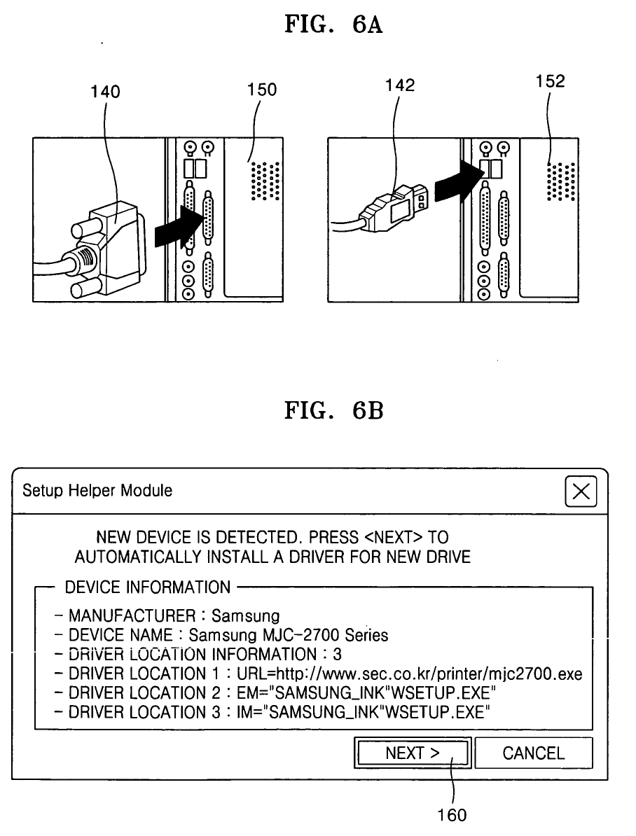

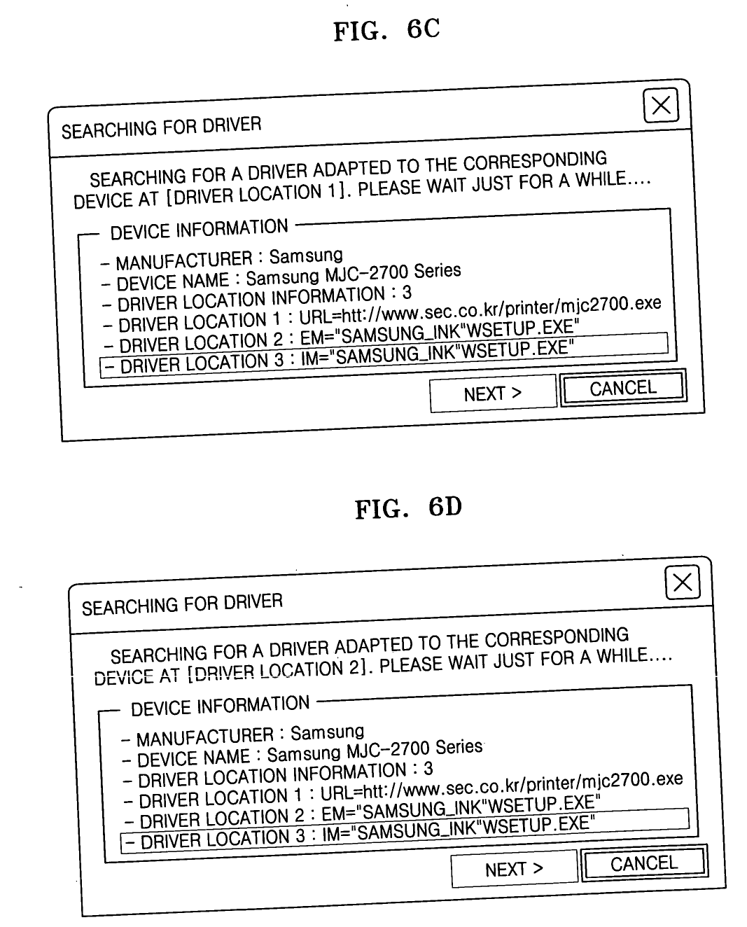

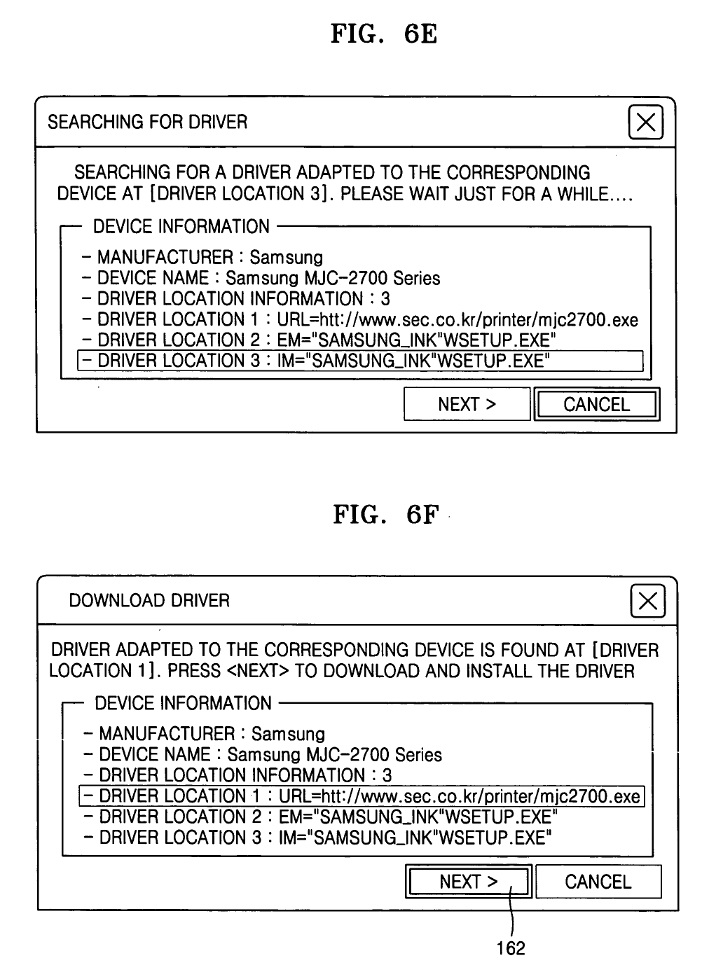

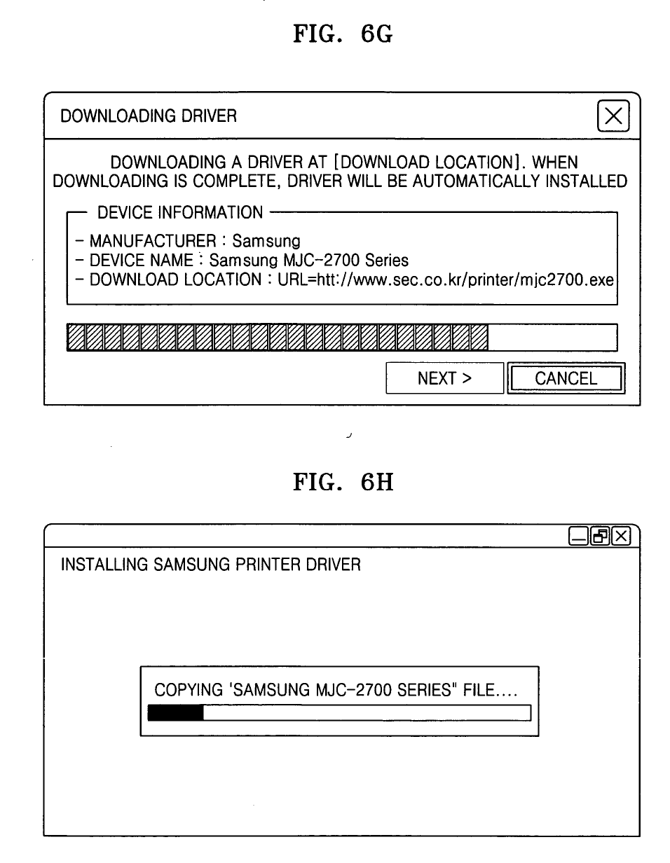

FIGS. 6a through 6h are views for describing the automatic driver installation method and apparatus according to an embodiment of the present invention, wherein FIG. 6a is a view in which a device is connected to a host 150 or 152 through a cable 140 or 142 and FIGS. 6b through 6h show exemplary user interface screens.

As shown in FIG. 6a, in a case where a device, for example, a peripheral device is connected to a host 150 or 152 through a cable 140 or 142, the first connection checker 100 which performs step 10 senses the connection and generates a first control signal C1 so that the first information input part 102 which performs step 12 receives device identification information from the device through the input terminal IN1. At this time, the first driver checker 104 that performs step 14 checks whether a driver adapted to drive the device connected to the host 150 or 152 through the cable 140 or 142 has been installed in the host 150 or 152.

If it is determined that no driver adapted to drive the device has been installed in the host 150 or 152, the information extractor 106 that performs step 16 extracts location information DRVSRC from the device identification information received from the first information input part 102.

The first driver installation unit 108 that performs step 18 installs a driver using the extracted location information. In more detail, first, the driver installation unit 108 shows a user interface screen as shown in FIG. 6b to a user. If the user selects NEXT 160 shown in FIG. 6b, a screen shown in FIG. 6c is displayed to the user. If no driver is found in a first location among driver locations, the automatic driver installation method according to an embodiment of the present invention tries to find a driver in a different location using the method shown in FIG. 2. That is, if no driver is found in a first location, the first driver installation unit 108 tries to find a driver in the location 2 and shows a screen shown in FIG. 6d to the user. Also, if no driver is found in the second location, the first driver installation unit 108 tries to find a driver in a third location and shows a screen shown in FIG. 6e to the user. If a driver is found in the first location, the first driver installation unit 108 shows a screen shown in FIG. 6f to the user. If the user selects NEXT 162 on the screen shown in FIG. 6f, the first driver installation unit 108 receives and downloads the driver through an input terminal IN2 and shows a screen shown in FIG. 6g to the user. The first driver installation unit 108 automatically installs the completely downloaded driver. If the device is a printer, a screen shown in FIG. 6h can be shown to the user when the driver is installed.

As described above, according to embodiments of the automatic driver installation method and apparatus and the computer readable recording medium for storing the computer program of the present invention, a driver adapted to drive a device is automatically installed in a host when the device is connected to the host. Therefore, a user does not need to manually install a driver for driving a device. That is, the user does not need to search for the location of a driver capable of driving the device. Also, in a case where the driver is provided through a network, manufacturers of devices do not need to provide separate media for storing the driver to users, thereby reducing driver development cost and service cost. In addition, when manufacturers of devices try to update a driver, it is possible to provide an updated driver directly to users in real time, since the manufacturers can merely change a driver provided on the manufacturer's home page over the Internet into an updated driver, thereby reducing manufacturing cost, maintenance cost, and repair cost. Also, since the host receives and reads the location information as well as the device identification information, a separate protocol for reading the location information from the device is unnecessary. That is, since the location information with the same format as the format of the device identification information to be read for identifying a device by host is created and is included in the device identification information, a separate tool allowing the host to identify the location information is unnecessary.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method for automatically installing a driver which drives a device in a host, the method comprising:
(a) determining whether the device is connected to the host;
(b) fetching device identification information from the device if it is determined that the device is connected to the host, wherein said device identification information specifically represents the connected device;
(c) extracting location information comprising at least one location in which the driver exists, from the device identification information if no driver adapted to drive the connected device has been installed in the host; and
(d) fetching the driver from a corresponding location among at least one location indicated by the extracted location information, and installing the driver in the host.

2. The method of claim 1, wherein the location information and the device identification information have a format of key data.

3. The method of claim 1, wherein the location information extracted in step (c) includes at least one among a network location, an internal location inside the host, and an external location outside the host.

4. The method of claim 3, wherein the location information extracted in step (c) includes the number of locations.

5. The method of claim 3, wherein step (d) comprises
determining whether the network location exists in the extracted location information;
determining whether the host can access the network location and can fetch and install the driver if it is determined that the network location exists;
determining whether the internal location exists in the extracted location information if it is determined that the network location does not exist in the location information or that the host cannot access the network location, fetch and install the driver;
determining whether the host can fetch the driver from the internal location and install the driver therein if it is determined that the internal location exists;
determining whether the external location exists in the extracted location information if it is determined that the internal location does not exist in the location information or that the host cannot fetch the driver from the internal location and install the driver therein;
determining whether the host can fetch the driver from the external location and install the driver therein if it is determined that the external location exists; and
accessing the network location, the internal location, or the external location and fetching and installing the driver if it is determined that the host can access the network location, the internal location, or the external location and fetch and install the driver.

6. The method of claim 5, further comprising inducing a user to install the driver manually if it is determined that the external information does not exist in the location information or that the host cannot access the external location and fetch and install the driver.

7. A method for automatically installing a driver that drives a device on a host, the method comprising:
determining whether the device is connected to the host;
fetching device identification information from the device if it is determined that the device is connected to the host, wherein the device identification information specifically represents the connected device;
extracting a query string from the fetched device identification information if no driver adapted to drive the connected device has been installed in the host;
transmitting the device identification information with the query string to a server that provides the driver; and
receiving the driver from a server that found the driver adapted to drive the device using the query string and the device identification information, and installing the driver in the host.

8. The method of claim 1, being performed by an operating system of the host.

9. The method of claim 1, wherein the device is an external device installed outside the host, or an internal device installed in the host.

10. An automatic driver installation apparatus for installing a driver that drives a device in a host, the automatic driver installation apparatus comprising:
a first connection checker, which checks whether the device is connected to the host and outputs the checked result as a first control signal;
a first information input part, which fetches device identification information specifically representing the connected device from the device, in response to the first control signal;
a first driver checker, which checks whether a driver adapted to drive the connected device has been installed in the host and outputs the checked result as a second control signal;
an information extractor, which extracts location information comprised of at least one location in which the driver exists from the device identification information received from the first information input part, in response to the second control signal; and
a first driver installation unit, which fetches the driver from a corresponding location among the at least one location indicated by the extracted location information received from the information extractor, and installs the driver in the host.

11. An automatic driver installation apparatus for installing a driver that drives a device on a host, the automatic driver installation apparatus comprising:
a second connection checker, which checks whether the device is connected to the host and outputs the checked result as a first control signal;
a second information input part, which fetches device identification information specifically representing the connected device from the device, in response to the first control signal;
a second driver checker, which checks whether a driver adapted to drive the connected device has been installed in the host and outputs the checked result as a second control signal;
a query string extractor, which extracts a query string from the device identification information received from the second information input part, in response to the second control signal;
an information transmitter, which transmits the device identification information with the query string to the server that provides the driver; and
a second driver installation unit, which receives the driver from a sever that finds the driver adapted to drive the device, using the query string and the device identification information, and installs the driver in the host.

12. A computer readable medium of instructions comprising at least one computer program adapted to control a system to install a driver to drive a device in a host, the computer program comprising:
a first set of instructions adapted to control the system to determine whether the device is connected to the host;
a second set of instructions adapted to control the system to fetch device identification information specifically representing the connected device from the device if it is determined that the device is connected to the host;
a third set of instructions adapted to control the system to extract location information comprising a location in which the device exists, from the device identification information if no driver adapted to drive the connected device has been installed in the host; and
a fourth set of instructions adapted to control the system to fetch the driver from the location indicated by the extracted location information and install the driver in the host.

13. A computer readable medium of instructions comprising at least one computer program adapted to control a system to install a driver to drive a device on a host, the computer program comprising:
a first set of instructions adapted to control the system to determine whether the device is connected to the host;
a second set of instructions adapted to control the system to fetch device identification information specifically representing the connected device from the device if it is determined that the device is connected to the host;
a third set of instructions adapted to control the system to extract a query string from the device identification information if no driver adapted to drive the connected device has been installed in the host;
a fourth set of instructions adapted to control the system to transmit the device identification information with the query string to a server which provides the driver; and
a fifth set of instructions adapted to control the system to receive the driver from a sever that find the driver adapted to drive the device using the query string and the device identification information, and install the driver in the host.
